(19) United States
(12) Patent Application Publication
(10) Pub. No.: US 2013/0246158 A1
(43) Pub. Date: Sep. 19, 2013

(54) POSTAL MAIL TO ELECTRONIC COMMUNICATION AND RELATED METHODS

(71) Applicants: Patrick Jerald Cannon, La Crosse, WI (US); Paul Herman Schultz, La Crosse, WI (US); David Lawrence Coleman, Sparta, WI (US); Shahrom Kiani, Onalaska, WI (US); Christian Dahling Kiani, Onalaska, WI (US); Carlos Macia, La Crescent, WI (US); Russell W. Guenthner, Glendale, AZ (US); David Lowell Bowne, La Crosse, WI (US)

(72) Inventors: Patrick Jerald Cannon, La Crosse, WI (US); Paul Herman Schultz, La Crosse, WI (US); David Lawrence Coleman, Sparta, WI (US); Shahrom Kiani, Onalaska, WI (US); Christian Dahling Kiani, Onalaska, WI (US); Carlos Macia, La Crescent, WI (US); Russell W. Guenthner, Glendale, AZ (US); David Lowell Bowne, La Crosse, WI (US)

(21) Appl. No.: 13/554,041

(22) Filed: Jul. 20, 2012

Related U.S. Application Data
(60) Provisional application No. 61/572,712, filed on Jul. 20, 2011.

(51) Int. Cl. G06F 17/30

(52) U.S. Cl. CPC G06F 17/30; G06Q 30/0236
USPC 705/14.36; 235/375

(57) ABSTRACT

A method, system and program product for managing and responding to receiving of mail items including the capture of a digital image by a mail item recipient taken of the outside of the mail item that includes the recipient and sender address blocks using, for example, a personal mobile intelligent communication device, and decoding a postal service barcode such as an Intelligent Mail Barcode.

### CROSS REFERENCE TO RELATED APPLICATIONS

This application claims priority to a U.S. Provisional Patent Application 61/572,712 filed Jul. 20, 2011 titled “SCAN MY MAIL POSTAL MAIL TO ELECTRONIC COMMUNICATION CONNECTION” with first named inventor Patrick Jerald Cannon, La Crosse, Wis. (US), which is expressly incorporated herein as though set forth in full.

### STATEMENT REGARDING FEDERALLY SPONSORED RESEARCH OR DEVELOPMENT

NONE

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The mailing industry has recently launched initiatives designed to increase the value of traditional mail and to build awareness around integrating mobile technology into traditional mail communications. Many businesses mail thousands or even millions of pieces of mail each month to customers, clients, and prospects. Such businesses include, for example, insurance companies, mortgages and finance companies, bulk mail advertisers, credit card companies, and charitable organizations. It is therefore no surprise that most people typically find several pieces of mail in their mailbox each day.

An Intelligent Mail™ Barcode (IMB) is a 65-bar code for use on mail in the United States. The term “Intelligent Mail” refers to services offered by the United States Postal Service for domestic mail delivery. The Intelligent Mail Barcode is intended to provide greater information and functionality than its predecessors POSTNET and PLANET. The Intelligent Mail barcode has also been referred to as One Code Solution and 4-State Customer Barcode abbreviated 4CB, 4-CB or USPS4CB. The complete specification of the barcode can be found in USPS Document USPS-B-3200E. The barcode effectively incorporates the routing ZIP code and tracking information included in previously used postal barcode standards. The Postal Service will require use of the Intelligent Mail barcode to qualify for automation prices beginning May 2011. Some of the benefits include improved deliverability, new services and increased overall efficiency. Similar codes and markings to the IMB may be used in other countries.

The Intelligent Mail barcode is a height-modulated barcode that encodes up to 31 decimal digits of mail-piece data into 65 vertical bars. The code is made up of four distinct symbols, which is why this barcode was once referred to as the 4-State Customer Barcode. Each bar contains the central “tracker” portion, and may contain an ascender, descender, neither, or both (a “full bar”). In total, the new barcode will carry a data payload of 31 digits representing the following elements.

The Barcode identifier is 2 digits indicating the degree of pre-sorting this mail piece received before being presented for mail delivery.

The Service type identifier is 3 digits and represents both the class of the mail (such as first-class, standard mail, or periodical), and any services requested by the sender.

The Mailer ID is 6 or 9 digits and is a number assigned by the USPS that identifies the specific business sending the mailing. Higher volume mailers are eligible to receive six-digit Mailer IDs, which have a larger range of sequence numbers associated with them; lower volume mailers will receive nine-digit Mailer IDs. To make it possible to distinguish six-digit IDs from nine-digit IDs, all six-digit IDs begin with a digit between 0 and 8, inclusive, while all nine-digit IDs begin with the digit 9.

The Sequence number, or Mailer Assigned Sequence Number is 9 or 6 digits and is a mailer-assigned six or nine-digit ID specific to this piece of mail, in other words, to identify the specific recipient or household, which the mailer must ensure is unique for a 45-day period after it is sent if you are claiming the Full Service discount; if not, it doesn't have to be unique. The Sequence Number is either six or nine digits, based on the length of the Mailer ID. If the Mailer ID is six digits long, then the Sequence Number is nine digits long, and vice versa, so that there will always be fifteen digits in total when the Mailer ID and the Sequence Number are combined.

The Delivery point ZIP code is 11 digits, and this section may be omitted. If it is present, the five, nine, or eleven-digit forms of the ZIP code are also encoded in the Intelligent Mail barcode. The full eleven-digit form includes the standard five-digit ZIP code, the ZIP+4 code, and a two-digit code indicating the exact delivery point. This is the same information that was encoded in the POSTNET barcode, which the Intelligent Mail barcode is intended to replace.

Managing the mail has traditionally been a manual task including opening each envelope and inspecting or reading its content to determine if any action should be taken. Unfortunately, many envelopes, especially those from bulk mailers, go directly into a trash can unopened or into a recycling bin. Furthermore, even some mail pieces that are actually opened can soon become forgotten, and even though an individual may intend to send a charitable contribution, take advantage of an offer or order a magazine those intentions may never be fulfilled because the opened mail piece ends up at the bottom of some paper stack.

Accordingly, a need exists for an improved method of managing mail items that overcomes certain limitations of more traditional approaches.

### BRIEF SUMMARY OF THE INVENTION

The present invention relates generally to mail processing, and more particularly to a method or system incorporating a method for managing mail pieces using a camera equipped personal mobile intelligent communication device such as an iPhone™ device or an Android™ device for automatically identifying the sender and the recipient of the mail item and transmitting this information to a central server for further processing and then subsequently forwarding relevant information to the sender of the mail item and, in some cases, receiving in return information from the sender destined for the recipient of the mail item. Identification of sender information or recipient information is aided by capturing and analyzing a digital image of a Postal Service Bar Code, typically printed on the surface of a mail item by the mail item sender (i.e. mailer).

Successful performance of the method of the present invention as described herein relative to certain illustrative embodiments provides for a mail recipient or recipients to utilize a camera equipped personal intelligent mobile communication device such as an iPhone™ device or Android™ device to capture a digital image or snapshot of the exterior of the mail piece. It should be understood that for discussion purposes a “digital image” or “snapshot” may include either a single digital image captured by the camera of cell phone or intelligent mobile communication device, or a series of multiple images captured from a “moving” video image from a cell phone video camera, or intelligent mobile communication device.

In general terms, this means that: (1) the snapshot includes both the recipient and the sender address block areas, (2) the snapshot is not out of focus, (3) the snapshot is taken in an adequately lighted area, (4) the snapshot does not suffer from excessive light reflection, skew or trapezoid effects and (5) an Intelligent Mail Barcode (or other barcode) is entirely visible (i.e. not cut off). The personal mobile intelligent communication device may include a processing capability to run an application program enabling a mail recipient to take a picture or to utilize a camera capability to capture an image, and to initiate and receive phone calls, emails, and text messages. Also, the intelligent communications device further includes the capability of being connected to the internet via either cell-phone or wireless LAN (local area network) technologies and capable through such internet connection to send and receive electronic communication between the personal communications device and a remotely located central server which also connects either directly or indirectly to the internet. The central server is not associated or “owned” by the recipient, and is remotely located from the location of the mail recipient. The intelligent communications device may further include a web browser component.

According to one aspect of the present invention, a sender sends a mail item via a mail service such as the United States Postal Service or Post Office to an individual mail item recipient. The individual mail item recipient receives the mail item, which is typically an envelope or package. The mail item typically includes on the outside of the envelope or package, a human readable written or printed sender address or sender identification, a written or printed recipient name and address, and further includes on the envelope or package “bar code” type information in an area easily scanned or observable. The bar code information typically does not include in encoded form, all of the written information on the package. The recipient of the mail is prompted, encouraged, or incentivized or requested to take a snapshot of the single mail item, for example using a Call to Action, using a mobile application program (app) installed on the personal intelligent mobile communication device. The mobile application program can be delivered to the recipient of the mail item from a web server, or delivered in other ways as would be typical of cell phone applications.

The mobile application program processes the digital image contained in the snapshot in order to decode one or more postal barcodes. The postal barcode, includes, but is not limited to a limited term mail identification code such as a Intelligent Mail Barcode (IMB). The decoded data may include information about the sender and the recipient of the mail item. The resulting decoded information and in certain cases, the digital image are transmitted by the intelligent mobile communication device to a central server for further processing. The central server includes the capability for transmitting the digital image to a video coding or optical character recognition application to fill in the sender's or recipient's information if they are missing. The central server also includes the capability of receiving back from the video coding or optical character recognition application, the missing sender's or recipient's information. The server may also be connected to act as a gateway between the intelligent mobile communication device of the individual mail item recipients and the information technology (IT) systems of the mail senders transmitting information back and forth as required for a particular application.

Of particular interest in the practice of the present invention are the fields describing the Mailer ID, and the Sequence Number. The Mailer ID typically identifies the specific business sending a mail item. The Sequence Number is assigned by the mailer or sender of the mail, and thus can be used to track or note specific groups of mail. For example, a particular advertisement mailing would be given one sequence number, and a second advertisement for a different item or date would be given a different sequence number.

The taking of a snapshot or capturing of a digital image by the recipient of the mail item, that is, with the recipient using his or her own camera equipped personal mobile communications device, provides a specific advantage in practice of the present invention. That is, a recipient's own cell phone device, in today's world, is typically very handy, and almost all cell phones today include a camera capability that allows for taking a picture or snapshot of adequate quality for enabling the recognition of a bar code and further of adequate quality for recognizing other mailing address or return address information obtained from a snapshot of the face of the mail item exterior.

The approach of taking a snapshot or capturing a digital image may provide advantages in different aspects of the present invention as compared to asking a mail recipient to use a bar code scanner, or to possibly use application software on the cell phone which might enable the cell phone optics to be used as a bar code scanner. A snapshot of the mail item or a snapshot of a selected portion of the outside of a mail item can be processed by software running on the cell phone, and/or the snapshot can be emailed or transferred in electronic form to a central server. Also, taking a snapshot does not require use of motion detecting algorithms or other requirements for recognizing a bar code which are well known to one knowledgeable in the state of the art for bar code scanners. The processing of the data in a snapshot can also be less complex because it is not necessary to recognize the bar code in real time, as in a bar code scanner. It is also not required that the item or the cell phone be moving in order to recognize the bar code.

It may be a further advantage in implementation of the invention to utilize a video feed of a series of frame images rather than a single “snapshot”. That is, a series of digital images from the “live” video feed of a cell phone camera are examined “live” and the decoding accomplished or retried until successful on each one of a series of live digital images. This would avoid the user having to choose a single snapshot moment, and the application could signal when the Postal barcode had been decoded rather than having the user try to get a “perfect” picture. This approach assumes the Postal Code barcode decoding is performed by an application on the cell phone rather than on a remote central server.

According to another aspect of the present invention, an individual mail item recipient receives a mail item from a retailer, for example, a large home improvement retailer, and is asked to take a snapshot of a mail piece using his or her own intelligent camera equipped mobile communication device. The mail recipient for example may be requested to go to a particular website and download a particular application program (app) to participate in incentive based program offerings. In this case, an app installed on the device processes the image, decodes a postal barcode such as the limited term mail identification code corresponding to the Intelligent Mail Barcode (IMB) found on the exterior of the mail piece and transmits the digital image and/or the decoded information to a server. The server, which may not be related to the retailer, processes the received information, identifies the name of the large home improvement retailer and transmits the recipient's information to that retailer's IT system. The retailer's IT system then transmits coupon information/coupon for the recipient back to the server or directly to the recipient. If sent to the server, the server, in turn, transmits the coupon information to the mail recipient's intelligent mobile communication device. The individual mail item recipient then may print the coupon or take the electronic coupon to the retail store to obtain the specified discount. The prospect of receiving such a coupon may thus serve as an inducement or a call to action for the mail recipient to take the picture of the mail piece in the first place. The advantage to the retailer of making this contact is that the retailer now knows the recipient has actually received and taken notice of the mail item, and may obtain further information as to the date and time the mail item was received and other information about the responding mail recipient.

For example, if the application is trusted by the mail recipient, the information sent to the server may include further personal preference information about the recipient retrieved from data stored on the mail recipient's mobile phone device or retrieved from other applications installed on the mobile phone device. This type of information about either a specific recipient or a broad group of recipients is well known to be valuable to retailers and others. Thus, collecting such information about a large plurality of individual mail item recipients has potentially good value in marketing, sales or in building social or other databases.

According to another aspect of the present invention, an individual mail item recipient receives a mail item in the form of a mail order catalog. He or she takes a snapshot of the address label of the mail order catalog using their personal intelligent mobile communication device, which in this modern day is typically “handy”. An optional app installed on the mail recipient's device processes the digital image, decodes any postal barcode such as the limited term Intelligent Mail Barcode (IMB) found on the address label and transmits the image and the decoded information to the catalog retailer's IT system. The catalog retailer's IT system identifies the name and address of the responding mail recipient using the decoded information and transmits back to the mail recipient's mobile device a dialog prompting or encouraging the recipient to take a snapshot of an item of interest in the catalog. After the mail recipient snapshots the item of interest, the app on the device processes the image of the item, decodes any barcodes, watermarks, markings, or product codes associated with the item found on the image, and transmits the image and the decoded information to the catalog retailer's IT system. Once the IT system processes the data it transmits back to the mail recipient's intelligent mobile communication device, a new dialog prompting the mail recipient to confirm the order. The app stored on the mobile device sends back to the IT system, the mail recipient's confirmation and the IT system finally transmits a receipt of the order to the mail recipient's intelligent mobile communication device.

It is noted and emphasized that an IMB code is already “printed” on the visible outer surface of most mail pieces because the US Postal Service provides beneficial rate advantages as an incentive for using Intelligent Mail Barcodes.

It is also noted and emphasized that the IMB code is unique when compared to other similar mail item codings that may be printed on mail items such as catalogs pages that might utilize QR codes. First of all the use of the IMB code is controlled by the US Post Office and at least certain portions of the IMB code would typically be correct in order for a mail item to be delivered to a mail recipient. Second, because the sender can always be identified based upon the IMB code an application that utilizes an IMB code might be judged much more secure than those utilizing QR codes which are uncontrolled and can contain direction to malicious websites.

The use of IMB codes having a shorter number of digits does not allow for immediate direction to an electronic address which may be a malicious web site. This overcomes a problem common with more general codes such as QR codes. Utilizing an IMB code to determine a web site address which is controlled by a centralized server allows for the server system to be programmed to avoid malicious web sites. Also, the sender is identifiable through the US Post Office which may deter maliciousness.

Further advantage is seen by utilizing the feature that certain portions of the IMB code can have limited lifetime for uniqueness, specifically for certain mailing fee discounts, a sequence number must be unique for 45-days.

An IMB code might also be judged to be significantly less obtrusive and “ugly” than QR codes. For example, the Mashable Tech article from http://mashable.com/2011/04/18/qr-code-design-tips/states: “The QR code: A thing of beauty or an eyesore? The magical barcodes that can be scanned by a smart phone to launch an offline-to-online experience are often criticized for their black and white checkerbox appearance. Those who doubt that QR codes will go mainstream are quick to point out that the look of QR codes will deter marketers and advertisers from using them.”

According to a further aspect of the present invention, an individual mail item recipient is provided with or receives notice of an incentive or a call to action to take a snapshot of the address label on a mail piece, including any bar code, and further including any hand written or printed address information on the mail piece, and then requested in such notice to convey the snapshot, or information derived from the snapshot to a particular identified server, the server typically being owned and/or operated by a party that is not the mail recipient. The snapshot is sent to a central server by the individual mail item recipient, possibly using a previously installed special app. The central server processes the snapshot or the derived information entered either by hand or from decoding the bar code depicted in the snapshot, determines the sender (i.e. mailer), and then sends information about the mail piece to the IT system of the sender. Then the IT system of the sender can initiate the sending of coupons, other “rewards”, special offers, or further communication with the responding mail recipient. This aspect of the invention provides a “forwarding service” that receives the snapshot or derived information from a large plurality of mail recipients and the service determines the sender and forwards related information about the mail piece to the sender, typically under control of the IT department of the sender.

According to still another aspect of the invention, a forwarding service utilizes a database for determining a sender based upon the sender-id in the bar code type information. This is an improvement that is useful when any bar code information does not provide complete sender address information, as for example with the United States Postal System (USPS) or any Postal Service or Post Office IMB (Intelligent Mail Barcode). The USPS IMB sender-id is simply a number assigned by the USPS and by itself is not directly indicative of the actual sender address. That is, it is just an assigned number not like a zip-code. By obtaining information describing the sender's address or identity beyond that which is provided in the sender-id field of an IMB, the forwarding service can build/accumulate/maintain a relationship between the sender-id number and the added information in a database that can be indexed by the sender-id field to provide for forwarding of other mail piece information based upon accessing the database using the number in the sender-id field. This concept is more readily understood if one realizes that the sender-id in the USPS IMB does NOT actually provide the identity of the sender in a form that is readily useful. The sender-id is just a number assigned by the USPS, and the relationship between a sender-id and a sender's address or identification may not be publicly or readily available.

According to a further aspect of the invention, a mail item is sent to an individual mail item recipient and the individual mail item recipient is encouraged/requested to take a snapshot of the address area on the exterior of the mail item. If it is not possible, or desirable that the snapshot be processed and analyzed for detection of bar codes by an application on the mail recipient's mobile communications device, then as an alternative an application or the individual mail item recipient can send to a central server, the snapshot of the address area on the mail item exterior. The decoding of any one or more bar codes can then be done with application software running on the central server, the software on the central server is assumed to be sophisticated enough to recognize bar codes that could not be decoded by the application software on the mail recipient's mobile communications device. The central server may further optionally employ recognition algorithms for determining the written addresses on exterior of the mail item. As an alternative, maybe a last resort, the snapshot information could be examined visually by a person to see if the written addresses are recognizable.

According to one or more aspects of the invention, an application program running on the mail recipient's cell phone, or personal communication device (such as iPad™) provides for “registration” guidance during the taking of the snapshot. That is, the application may provide guiding features in the “viewfinder” picture displayed on the device or cell phone during preparation for taking of the picture. Also, the application software may optionally provide for processing during the picture taking preparation time which can inform the mail recipient whether the IMB information is being recognized, and to provide feedback as to whether further address information is clearly visible in the snapshot, whether lighting is adequate, and whether the focus of the camera is adjusted correctly. Advice to the picture taking can also include suggesting the use of flash to improve lighting. The application software might optionally suggest that two or more snapshots may be required to provide for better recognition of the bar code or the additional further mail address information.

The above aspects of the present invention provide several advantages. For example, such advantages include:

the value of physical mail is improved so that more physical mail can be used;

improved interaction between physical communication (such as mail) and electronic communication by the mail recipient of the physical communication (mail) (such as text, chat, or email messages);

capability for adding information to a database based upon information collected from inducing or encouraging individual physical mail recipients to interact electronically, over the internet, so as to increase the value of mail, typically to the sender, but also to the recipient of the mail;

electronic communication by a recipient of a mail item is encouraged or incentivized, wherein the communication increases the usefulness of the mail item, or encourages further interaction between the sender of the mail item, and the receiver of a mail item.

Another aspect or feature of the present invention provides, a method that includes a step to encourage or induce electronic communication by a recipient of a mail item, wherein the communication increases the usefulness of the mail item, or encourages further interaction between the sender of the mail item, and the receiver of a mail item.

Another aspect or feature of the present invention provides a method that includes a step to encourage or induce ordering of goods or services electronically over the internet following reception of a mail item by an individual recipient, and to encourage electronic communication between the mail recipient and the sender, or a service related to the sender.

Another aspect or feature of the present invention provides a method to increase the ease of ordering goods or services from a sending company as described or promoted in a physical mail item, by inducing or encouraging electronic communication between the physical mail item recipient and the sending or mailing company.

Another aspect or feature of the present invention provides a method that provides for a bill to be paid conveniently by invoking an application on the personal mobile communications device which allows a mail recipient to scan or snapshot a bar code or identifying mark on the mail item, this action supplying a confirmation of intent to pay the bill, or to register the bill into a mail recipient database for tracking purposes, or for paying later.

Another aspect or feature of the present invention provides a method that includes steps for ordering from a catalog using the combination of IMB and product bar codes or IDs. This provides for time saving and potentially increased sales due to convenience and instantaneous gratification to the user.

Another aspect or feature of the present invention provides a method that includes steps for performing account verification or account creation. Such steps help prevent someone from stealing a catalog and charging unwanted things to an account and then providing a different shipping address.

Another aspect or feature of the present invention provides a method that includes steps for relating a specific cell phone to a mail recipient's account. This provides an advantage in that only a verified or registered cell phone which is known to belong to the mail recipient can be used to actually order things, or to invoke or purchase other goods or services which may be related to a physical mail item.

Another aspect or feature of the present invention provides a method that includes steps for sending a picture of the entire mail item back to the sender, and/or to the Post Office in order to provide an indication of the condition of the package when it was received.

Another aspect or feature of the present invention provides a method including steps for an advertiser to mail a lightweight mail item such as a post card, and then scan the IMB or other code to provide a link on the mail recipient's personal mobile communications device to a more complete or “full” catalog. This allows a mail item to be sent out less expensively (as a post card), while enabling the mail recipient to gain access to the advertiser's complete catalog.

Another aspect or feature of the present invention provides a method that includes steps for scanning a bar code placed on the label of a mail item that provides instantaneous or spot feedback to the seller of an item.

Another aspect of the present invention provides a method including steps for initiating a dialog or a request for information from a mail recipient about when to deliver a package that requires signature. This can apply to all couriers. A card or attachment is included or fastened to the mail item that can be torn off by the courier and left at the door, which is then scanned by the mail recipient during use of an application on the personal mobile communications device that in turn requests the mail recipient to provide further information to help allow for delivery of the package at a convenient time. The communications device application can be programmed to enable the mail recipient to also decline delivery. Electronic communication between the mail recipient and a mail courier is initiated based upon scanning a bar code which includes enough information to allow a central server to forward an electronic message to a related party.

Some benefits of establishing a verifiable association between a mail item, the receipt of a mail item, and electronic communication establishing a link between a mail recipient and the sender are illustrated in a two page table shown in FIGS. 10a, and 10b. The table in these two figures sets forth a range of services based upon establishing the electronic connection between a physical mail sender, and a mail recipient.

### BRIEF DESCRIPTION OF THE SEVERAL VIEWS OF THE DRAWINGS

The invention is better understood by reading the detailed description of the invention in conjunction with the accompanying drawings.

FIG. 1 illustrates the high level processing operational flow for managing mail pieces performed by a system incorporating the method or teachings of the present invention.

FIG. 2 illustrates the processing logic performed at the intelligent mobile communication device of FIG. 1.

FIG. 3 illustrates the processing logic sequence of operations performed at the server of FIG. 1.

FIG. 4 illustrates the processing logic sequence of operations performed at the sender's IT system of FIG. 1.

FIG. 5 illustrates the processing logic sequence of operations performed by the system of FIG. 1 when the mail piece is a mail order catalog.

FIG. 6 illustrates a flow of data and commands between hardware and software elements as might be typically carried out in practice of the method of the present invention.

FIG. 7 illustrates the processing logic sequence of operations for providing a web page personalized for a specific mail recipient based on the information decoded from the IMB.

FIG. 8a illustrates a first exemplary web template as may be stored in a web server database for processing and then delivery to a mail recipient based upon capturing of a digital image of a received mail item, the digital image including a Postal Service Barcode providing specific mail recipient information.

FIG. 8a illustrates a second exemplary web template similar to that of FIG. 8a.

FIG. 9 illustrates an exemplary report based upon data derived from a database describing a plurality of captured images of mail items received by specific mail recipients.

FIG. 10a and FIG. 10b are tables illustrating a range of services based upon establishing the electronic connection between a physical mail sender, and a mail recipient.

### DETAILED DESCRIPTION OF THE INVENTION

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the illustrated embodiments. The disclosed embodiments may be combined, other embodiments may be utilized or structural or logical changes may be made without departing from the scope of the invention. The following detailed description is, therefore, not to be taken in a limiting sense and the scope of the invention is defined by the appended claims and their legal equivalents.

The present invention according to an illustrated embodiment is directed to an improved method and system for managing mail items that overcomes the limitations of traditional approaches used in managing mail items. The method or methodology is offered to individual mail item recipients through a mobile application program (app) downloaded onto an intelligent mobile communication device such as, but not limited to, an iPhone™ device or Android™ device. The app is particularly applicable to managing mail received from high volume (bulk) mail senders such as credit card companies or charitable organizations, but is also applicable for managing mail received from any business mail sender. The methodology of the process or method is described as follows.

The digital image or “snapshot” of an outside address area of each mail piece is captured using the built-in camera included in an intelligent mobile communication device. In one or more embodiments, it is helpful that the image contain both the destination and return addresses and if any postal barcode such as a limited term mail identification code, such as, but not limited to the Intelligent Mail Barcode (IMB), POSTNET or PLANET that are present on the mail piece. It is helpful when the barcodes should be visible and not cut off on the image. The limited term mail identification code can include a one dimensional or two or more dimensional symbology, for example that includes routing and/or tracking information that uniquely identifies the mail, the mail recipient, or the mail sender for a temporary period of time. It is individualized to a particular parameter such as routing and/or tracking information. The term can be limited, for example, the code can be re-assigned after a period of time. The mail identification code can uniquely identify the sender, the receiver, the mail piece, or combinations thereof. The IMB code includes a sender identification, recipient information, such as in the form of a serial number, and a delivery point code. The IMB can include 5, 9, or 11 digits. In the illustrated embodiments, the IMB includes an eleven digit postal code.

The user starts the app that provides positional guidance with the aid of a rectangular frame that is colored as for example, in red while the camera is initially being positioned over the mail piece. The frame eventually turns a second color such as green when an acceptable position is detected by the device. The app uses the device's internal gyroscope to measure and detect an acceptable position. Once the frame becomes green the user pushes a button on the device to take the snapshot of the outside address area of the mail item. After the snapshot is taken, the app processes the snapshot and makes it ready for transmission over the air (OTA) or via a Wi-Fi connection. The app also includes circuitry that attempts to detect any limited term mail identification code, including, but not limited to a postal barcode such as the IMB, POSTNET or PLANET present on the mail piece. If a limited term mail identification code, such as a barcode is detected, it is decoded and the decoded information is presented to the mail recipient or user. The app then transmits the image and all decoded information to a remotely located server.

Once the server receives the image and the decoded information, it attempts to identify the sender and the recipient of the mail piece. If the sender or the recipient cannot be identified using the decoded information received from the intelligent mobile communication device the server transmits the image to a video coding or optical character recognition (OCR) application where an operator (video coder) or OCR software module fills in the missing information. The video coder or OCR application sends back to the server the infatuation that the operator or OCR software module has completed. Once the server has assembled/obtained all the information required to properly identify the sender and the recipient, the data, and in some cases the image as well, are transmitted to the information technology (IT) system of the sender.

The sender's IT system processes the received information and, in one or more embodiments, determines if any additional information needs to be sent back to the recipient at this time or at a later date. When data needs to be sent to the recipient, for example, the IT system transmits this data to the server or directly to the intelligent mobile communication device. When the server acts as a gateway between senders and recipients it transmits the data provided by the sender to the intelligent mobile communication device of the mail recipient. The type of data that a sender transmits to a mobile device may include a report or historical information, a bill due amount and date, a coupon such as a discount coupon, a commercial offer or solicitation, a charitable donation solicitation, a reminder, a confirmation, a dialog requesting additional input from the individual mail item recipient, web page, recipient-personalized web page, etc.

Description of High Level Processing Flow

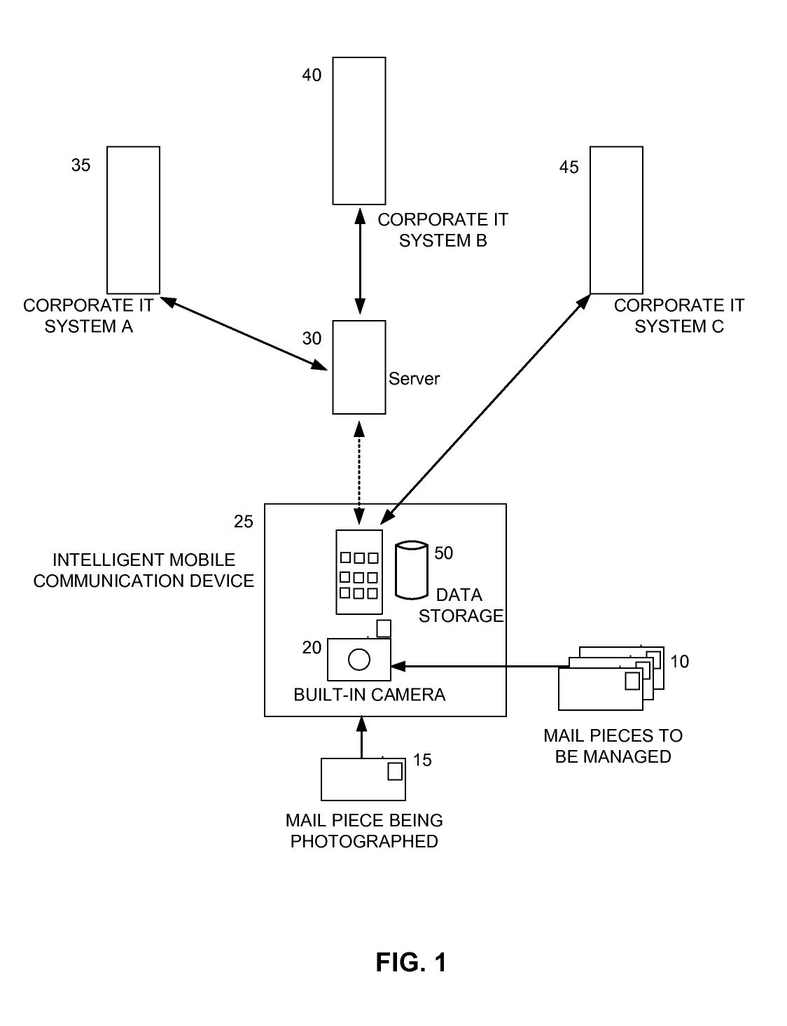

Referring to FIG. 1, the processing flow carried out by a system incorporating the teachings of the present invention will now be described. As shown, a collection of mail pieces 10 are managed or carried out by taking a picture of each mail piece 15 using the built-in camera 20 of an intelligent mobile communication device 25. The device 25 attempts to read and decode any limited term mail identification code such as postal barcode information present on the image and may compress the image as necessary. The image and the decoded information are transmitted by device 25 for example over the air (OTA) or via Wi-Fi connection to a gateway server 30 or to a corporate IT system 45 of FIG. 1. If a gateway server 30 is used, the server processes the data received from the intelligent mobile communication device 25 and in some cases it transmits data to a corporate IT system 35, 40. The corporate IT systems 35, 40, 45 of FIG. 1 process the data received from the gateway server 30 or directly from the intelligent mobile communication device 25 and in some cases the IT systems return data back to the gateway server 30 or directly to the mobile device 25.

The mobile application (app) uses a local data store 50 included in device 25, such as a database, to keep track of mail piece information decoded by the app such as sender information and recipient information as well as mail piece information received from the gateway server 30 or from the corporate IT system 35, 40, 45 such as sender information, recipient information, bill due dates, subscription renewal dates, commercial offers, placed commercial orders, charitable organization offers, and placed charitable donations. According to one embodiment, the app generates reports organized under a variety of different categories such as sender, recipient, mail piece type, transaction type, time/date, and action required.

### Description of Device Performed Processing Logic

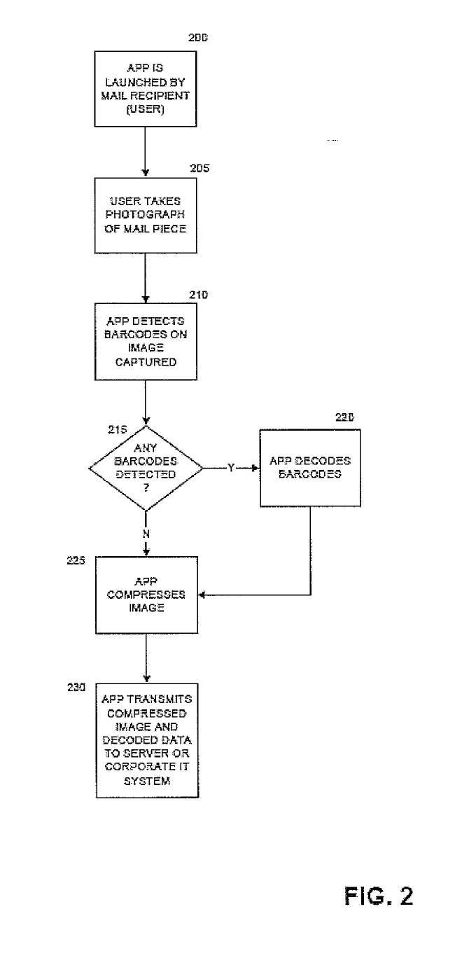

FIG. 2 is a flow chart that illustrates in greater detail, the processing logic performed in conjunction with the intelligent mobile communication device 25 of FIG. 1. As indicated in block 200, the individual mail item recipient launches a mobile application (app) to take a snapshot of the mail piece (i.e. block 205). As indicated in block 210, the app processes/scans the image to detect if any postal barcode such as IMB, POSTNET or PLANET are present on the mail piece (i.e. block 215). If a barcode is detected the app decodes the information contained within the barcode as indicated in block 220. Once the barcodes are decoded the image may be compressed as required as indicated in block 225 before transmitting it over the air (OTA) or via Wi-Fi to a server 30 or to a corporate IT system 35, 40, 45 as indicated in block 230.

### Description of Server Performed Processing Logic

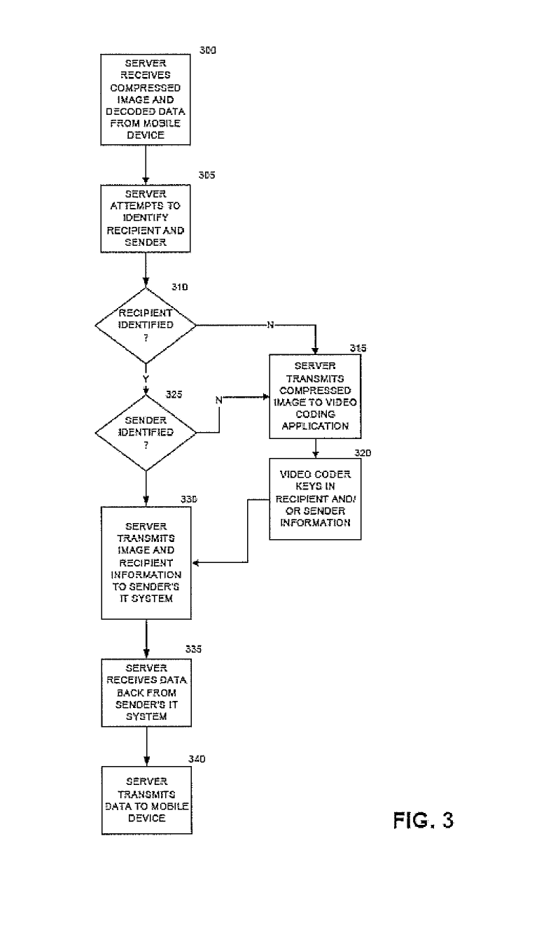

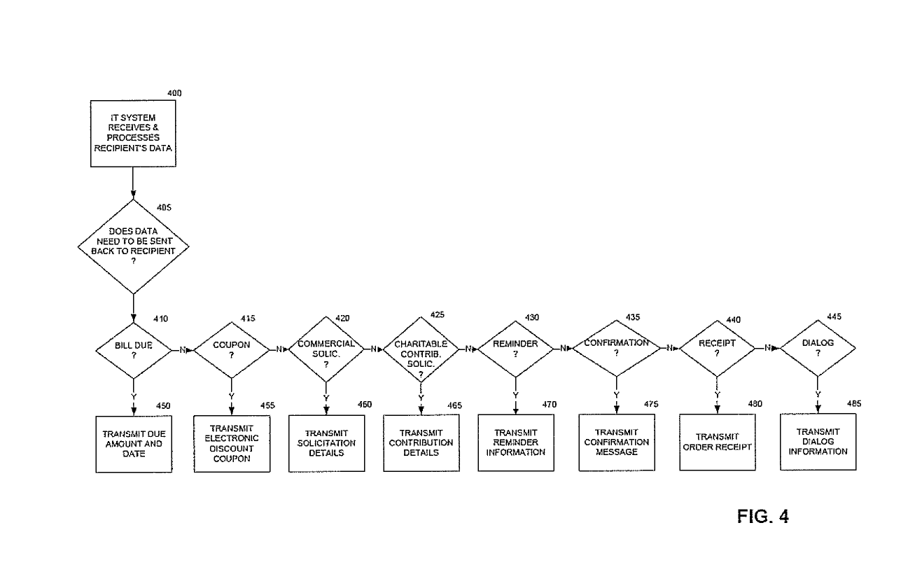

FIG. 3 illustrates in greater detail the processing logic performed at the server 30 of FIG. 1. As indicated in block 300, the server 30 receives the image and the decoded data from the intelligent mobile communication device 25. The server 30 attempts to identify who the recipient and the sender are as indicated in block 305. If the recipient cannot be identified (i.e. block 310) or the sender cannot be identified (i.e. block 325) from the decoded data received, the image is transmitted to a video coder or optical character recognition (OCR) application as indicated in block 315 where a video coder or OCR software module fills in the missing information (i.e. block 320). Once the recipient and the sender are identified by server 30, the image and the recipient information are in some cases transmitted to the sender's IT system for further processing as indicated in block 330. The server 30 in some cases receives data back from the sender's IT system intended for the recipient as shown in block 335. The server 30 then sends data back to the intelligent mobile communication device as shown in block 340.

### Description of Sender IT System Performed Processing Logic

FIG. 4 illustrates in greater detail the processing logic performed at the sender's IT system 35, 40, 45 of FIG. 1. As indicated in block 400, the sender's IT system processes the recipient's data received from the server 30 or from the intelligent mobile communication device 25. The data received may include the image, the recipient's information, the sender's information and any other data processed by the server 30 or the mobile device 25. As indicated in block 405, the sender's IT system determines if data needs to be sent back to the mobile device depending on the type of application, examples of which may include bills due (i.e. block 410), distribution of discount coupons (i.e. block 415), a commercial offer or solicitation (i.e. block 420), a charitable contribution solicitation (i.e. block 425), a reminder (i.e. block 430), a confirmation (i.e. block 435), a receipt (i.e. block 440), or a dialog back to the recipient prompting for additional information (i.e. block 445). If the specific application requires data to be sent back to the recipient, the sender's IT system transmits to the server or to the mobile device the appropriate data, examples of which may include due amount and date (i.e. block 450), an electronic coupon (i.e. block 455), commercial solicitation details (i.e. block 460), charitable contribution details (i.e. block 465), reminder information (i.e. block 470), confirmation messages (i.e. block 475), order receipts (i.e. block 480), or dialog information (i.e. block 485).

An application that includes the distribution of electronic coupons (i.e. block 415) is intended to incentivize the individual mail item recipient to use the illustrated method of the present invention. The electronic coupon may consist of a barcode that a retailer can directly scan from the mobile communication device or may require the recipient to print the discount coupon.

An application that includes transmitting reminders (i.e. block 430) by the sender is intended to help the individual mail item recipient track when certain actions such as mailing a payment or renew a subscription are due.

### Description of Mail Order Catalog Processing Logic

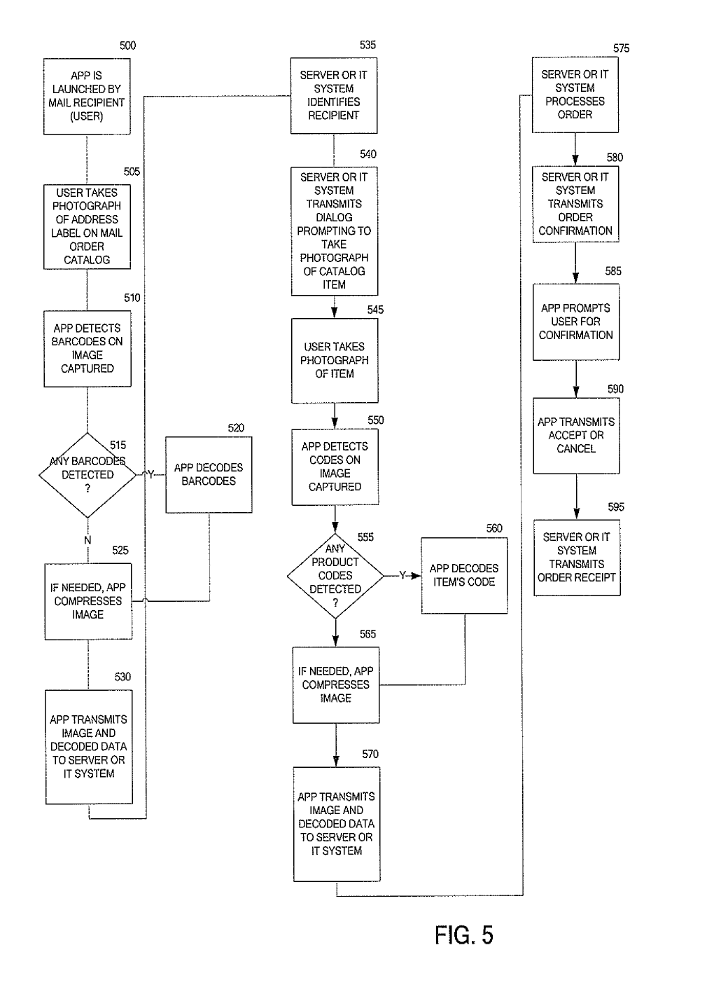

FIG. 5 illustrates the processing logic performed by the system of FIG. 1 when the mail piece is a mail order catalog. As indicated in block 500, the individual mail item recipient launches a mobile application (app) to take a snapshot of the address label on the mail order catalog 505. The app processes the image to detect in block 510 if any limited term mail identification codes including postal barcodes such as IMB, POSTNET or PLANET are present on the image. If a barcode is detected in block 515, the app decodes the information contained within the code as indicated in block 520. Once the codes are decoded the image may be compressed in block 525 before transmitting it to a server 30 or to the sender's corporate IT system 35, 40, 45 as indicated in block 530. The server 30 or the IT system identifies the recipient as indicated in block 535 and transmits a dialog back to the app prompting the user to take a snapshot of the catalog item as indicated in block 540. After the mail recipient/user takes the snapshot (i.e. block 545), the app processes the image to detect in block 550 any code that may be associated with the item. If a barcode is detected in block 555, the app decodes the information contained within the code (i.e. block 560), may compress the image in block 565 and transmits the image and decoded data to the server or IT system as indicated in block 570. The server 30 or IT system processes the item order received (i.e. block 575) and transmits back to the app an order confirmation dialog as indicated in block 580. The app prompts the user or mail recipient to confirm the order as indicated in block 585 and transmits the acceptance or cancellation to the server or IT system as indicated in block 590. Finally, the server or IT system transmits to the app the order receipt as indicated in block 595.

The transmission method between the intelligent mobile communication device and the server or corporate IT system may include electronic communication methods such as web based protocols and email.

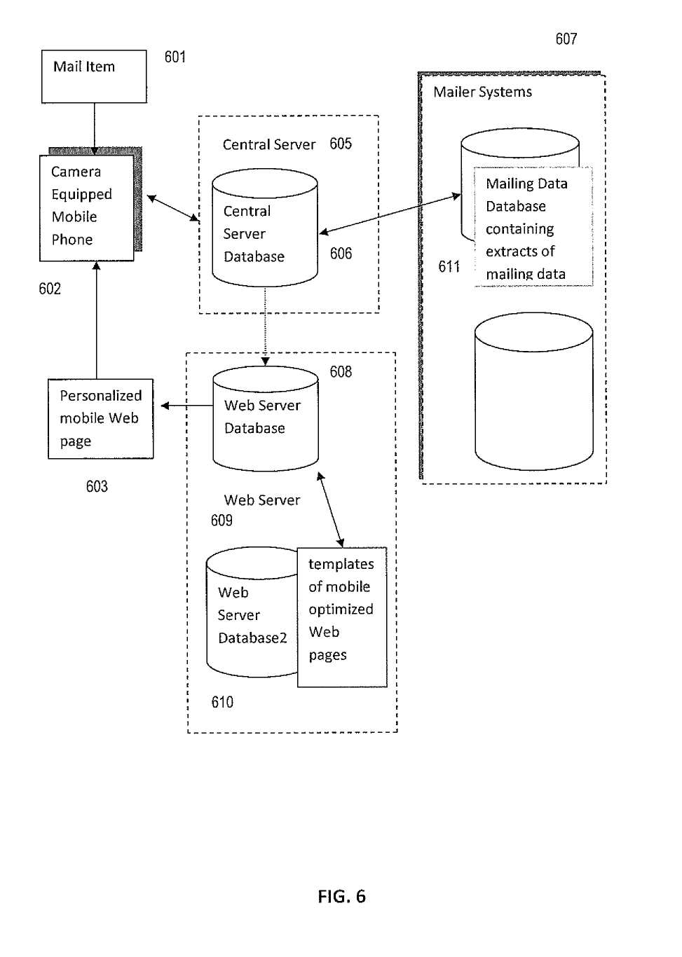

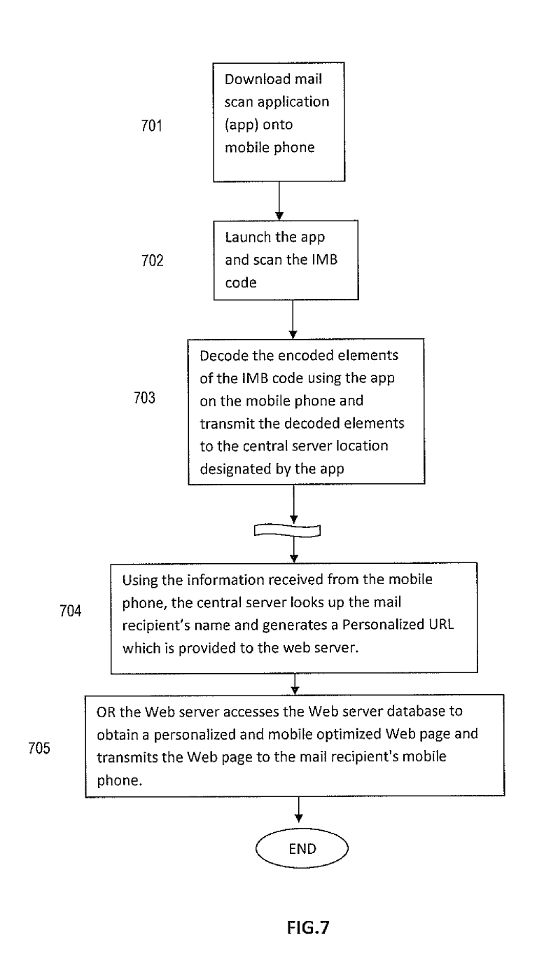

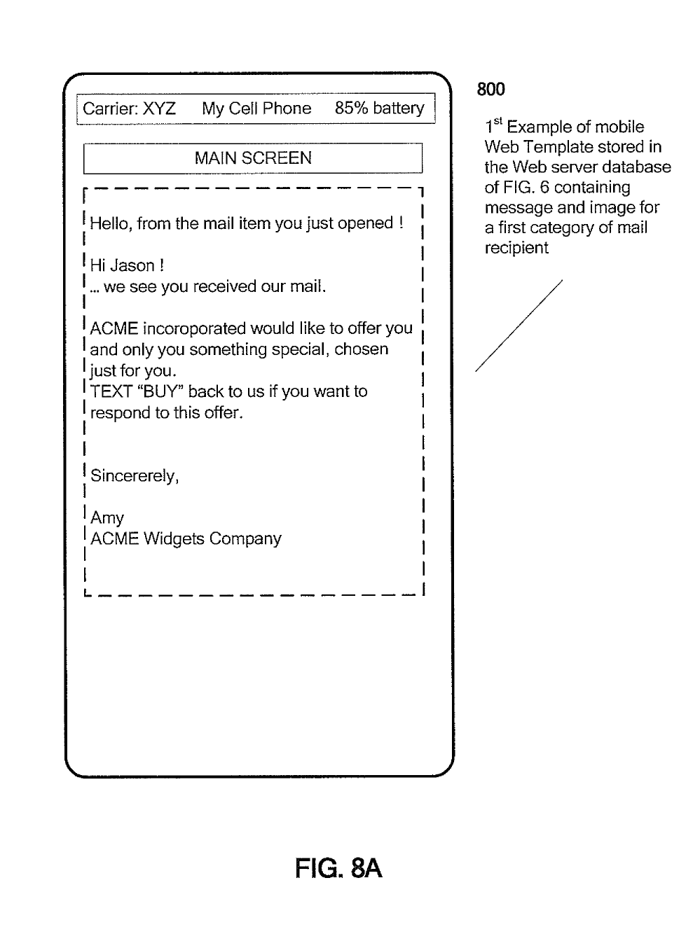

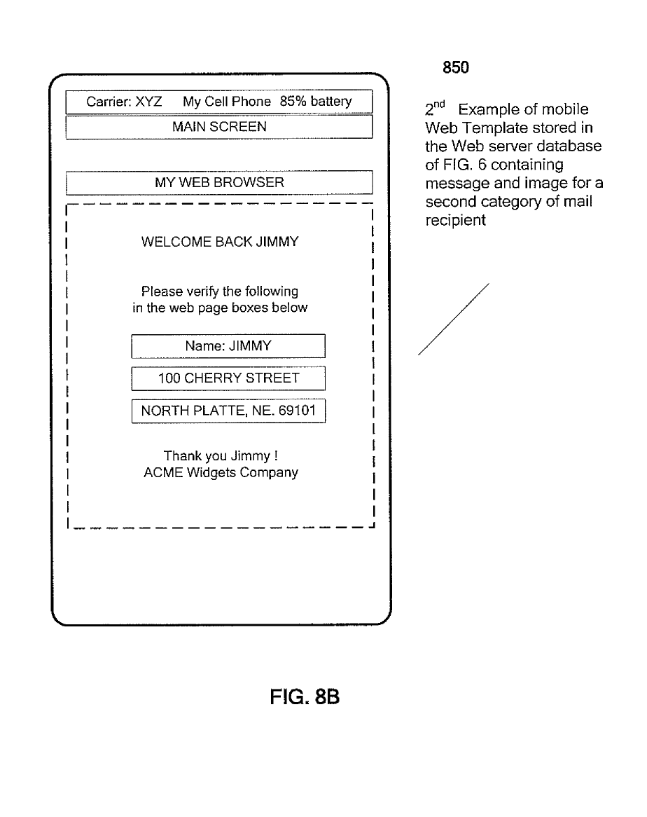

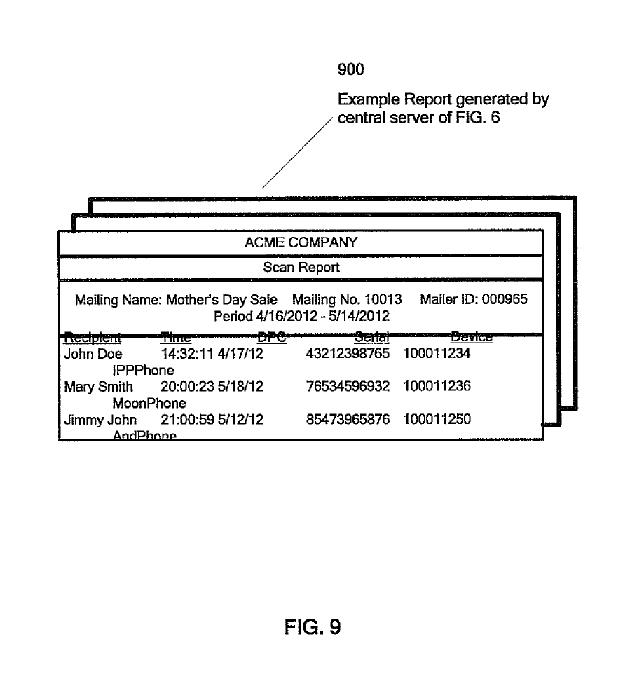

FIG. 6 illustrates a flow of data and commands between hardware and software elements of a system as might be typical in practice of the method of the present invention. A mail item 601 is received by a mail item recipient. The mail item recipient utilizes his own camera equipped mobile phone 602 to capture a digital image of the outer surface of the mail, the image including within the area of the image the Postal Service Code (e.g. IMB). The IMB of the image, and optionally other information relating to the mail item, are decoded and the decoded information is utilized to access a central server database 606 of a central server 605. The central server initiates access to a Mailer System server 607 running a Mailing Data Database 611. The central server is thus provided with a mailer information, and other mail item information. The central server 605, based upon the specific mail item recipient, the mailer information, and any other mail item information can then build a personalized web page 603 for delivery to the camera equipped mobile phone 602 by optionally accessing templates 610 stored on the web server 609 and other information from an optional web server database 608.

FIG. 7 illustrates the processing logic sequence of operations for providing a web page personalized for a specific mail recipient based on the information decoded from the IMB. An application 701 is provided or already loaded onto a mail recipient's mobile phone. The application 701 is launched by the mail item recipient 702. An image of the mail item is captured and the IMB code of the mail item is decoded 703. In response, as indicated in block 704 using this decoded information a central server can look up the mail recipients name and generate a personalized URL which can be sent back to the mail recipient/user's cell phone for display by the browser software component of the cell phone. As an alternative, as indicated in block 705, the central server or web server may access further information from a database to form a web page specifically tailored for the type or category of mail recipient/user.

FIG. 8a illustrates a first exemplary web template 800 that may be stored in a web server database of FIG. 6 for processing and then delivery to a mail recipient based upon capturing of a digital image of a received mail item, the digital image including a Postal Service Barcode providing specific mail recipient information.

FIG. 8b illustrates a second exemplary web template 850 similar to that of FIG. 8a that also may be stored in the web server database of FIG. 6.

FIG. 9 illustrates an exemplary report 900 based upon data derived from a database storing data describing a plurality of captured images of mail items received by specific mail recipients.

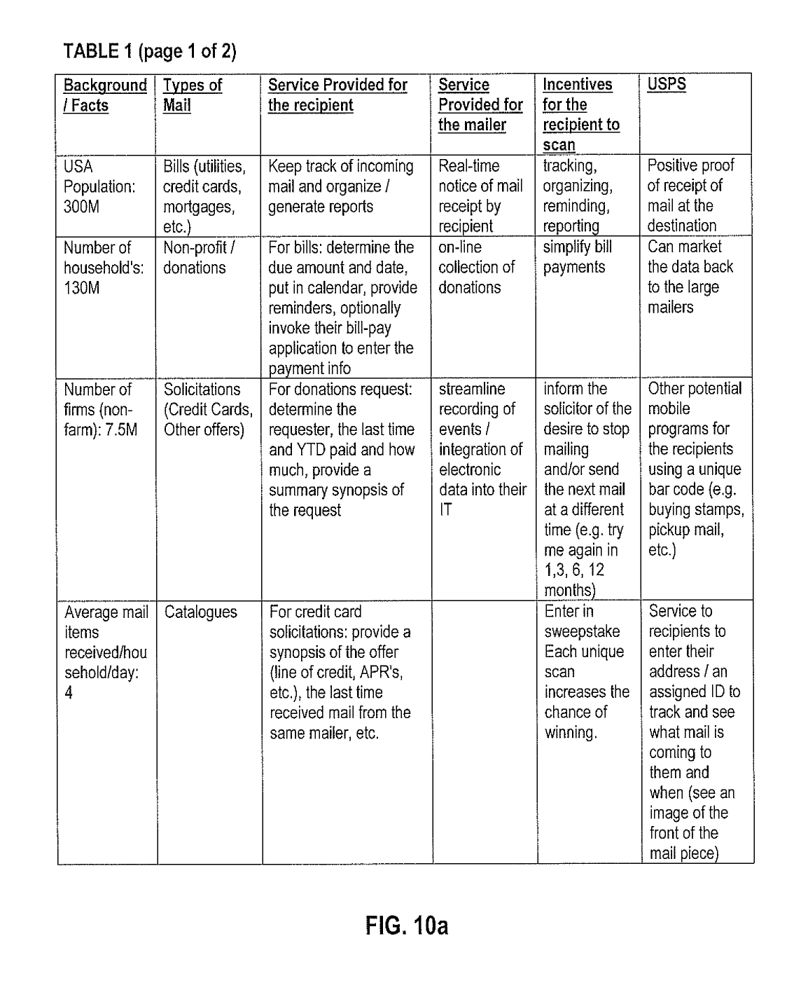

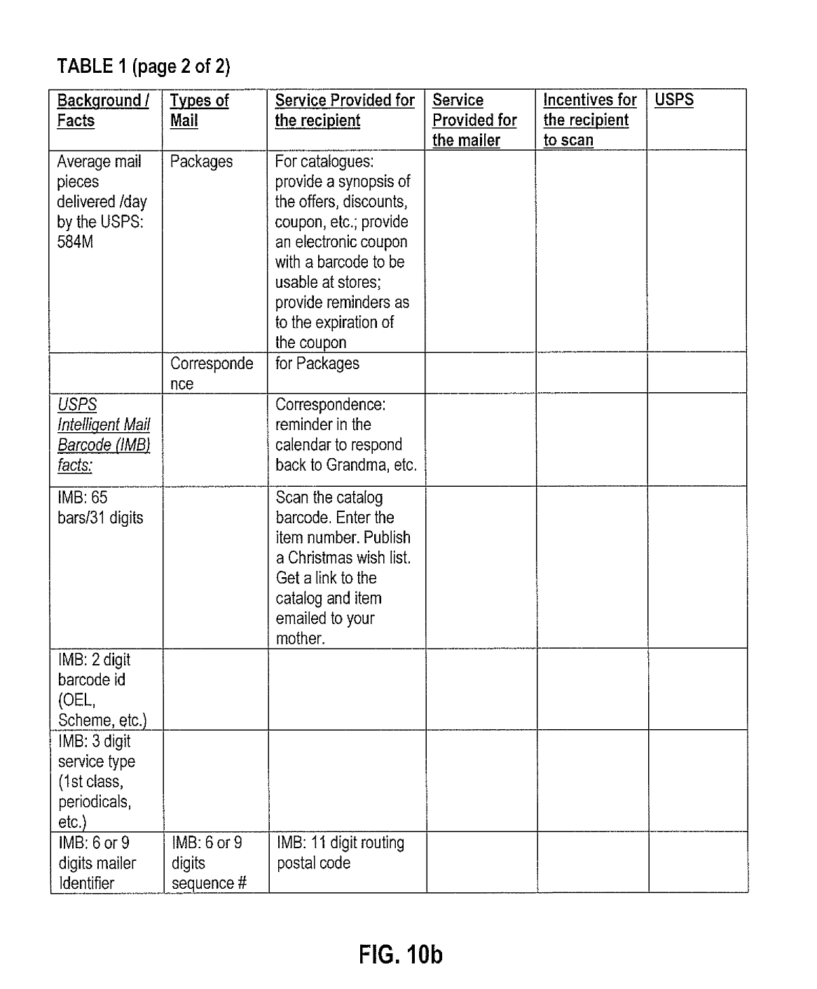

FIG. 10a and FIG. 10b are tables that illustrate a range of services based upon establishing the electronic connection between a physical mail sender, and a mail recipient.

It is to be understood that the above description is intended to be illustrative, and not restrictive. Many other embodiments will be apparent to those of skill in the art upon reading and understanding the above description. It should be noted that embodiments discussed in different portions of the description or referred to in different drawings can be combined to form additional embodiments of the present application. The scope should, therefore, be determined with reference to the appended claims, along with the full scope of equivalents to which such claims are entitled.

We claim:

1) A method of processing data relating to a number of received mail items mailed by a mail item sender and received by one or more mail item recipients, the received mail items including an Intelligent Mail Barcode on an area of the mail item visible outer surface, the Intelligent Mail Barcode having a height based bar code containing in encoded form, a number of Intelligent Mail Barcode elements including a Mailer Identification Number, a limited term Mailer Assigned Recipient Sequence number, and a Delivery Point Zip Code, the method comprising:
A) receiving at a central server captured mail item information relating to a digital image of at least a portion of the visible outer surface of the received mail item captured by the mail item recipient utilizing the mail item recipient's own personal camera equipped mobile intelligent communications device with the captured digital image, and including in an area of the image the Intelligent Mail Barcode, the receiving of the captured mail item information verifying actual reception of the mail item by the mail item recipient; and,
B) in response to the receiving of the captured mail item information by the central server, storing information relating to the received mail item into a first mailing information database or into a second mailing information database on a second server, the stored information derived from the verified actual reception of the mail item by the mail item recipient as identified by the Mailer Assigned Recipient Sequence number and the Mailer Identification Number decoded from the captured digital image.

2) The method of claim 1 further comprising: accessing the first or second mail item database to obtain further mail item information previously stored in the first or second mail item database, and then utilizing the further mail item information in responding to the mail item recipient.

3) The method of claim 1 further comprising: accessing the first or second mail item database to obtain further mail item information previously stored in the first or second mail item database, and utilizing the further mail item information to send an electronic message to the mail item sender.

4) The method as recited in claim 1 further comprising: incentivizing the mail item by providing an incentive associated with mailing of the received mail item for causing the recipient to obtain the captured digital image utilizing the mail item recipient own personal camera equipped mobile intelligent communications device.

5) The method as recited in claim 1 further comprising: providing the mail item recipient an application for running on the mail item recipient own personal camera equipped mobile intelligent communications device to capture the captured digital image.

6) The method of claim 1, further comprising: transferring electronically to a remote server information descriptive of the mail item recipient utilizing an electronic address of the remote server derived from the Mailer Identification Number on the received mail items.

7) The method as recited in claim 1, further comprising: determining Further Sender Identification Information from an area of the captured digital image located beyond the area containing the Intelligent Mail Barcode, and storing that information into the first or second mail item database.

8) A method of processing data relating to a number of received mail items mailed by a mail item sender and received by one or more mail item recipients, the received mail items including a Postal Service Bar Code on an area of the mail item visible outer surface, the Postal Service Bar Code comprising a height based bar code and including in encoded form Postal Service Bar Code elements comprising a mail item sender identification number, a mail item sender assigned sequence number, and a mail item recipient delivery code, the method comprising:
A) receiving at a central server captured mail item information relating to a captured digital image of at least a portion of the received mail item, the captured digital image captured by the mail item recipient utilizing the mail item recipient's own personal camera equipped mobile intelligent communications device with the captured digital image and including in an area of the image the Postal Service Bar Code, the receiving of the captured mail item information verifying actual reception of the mail item by the mail item recipient, and
B) in response to the receiving of the captured mail item information by the central server, storing receipt information relating to the received mail item into a first mailing information database or into a second mailing information database on a second server, the stored receipt information based upon the verified actual reception of the mail item by the mail item recipient and one or more of the Postal Service Bar Code elements decoded from the captured digital image.

9) The method of claim 8 wherein the sequence number assigned by the mail item sender assigned sequence number is valid only for a limited period of time.

10) The method as recited in claim 8, wherein the own personal camera equipped mobile intelligent communications device includes an application stored thereon to decode one or more of the Postal Service Bar Code elements and to transmit one or more of those elements to the central server.

11) The method as recited in claim 8, further comprising: prompting the mail item recipient to enter further recipient information into the personal camera equipped mobile intelligent communications device and transmit at least a portion of that further recipient information to the central server.

12) A method of collecting data relating to a number of mail items received by a plurality of mail item recipients, the mail items including an Intelligent Mail Barcode on an area of the mail item visible outer surface, the method comprising:
A) receiving information at a central server from a plurality of captured digital images of each of the received mail items the captured digital images including the Intelligent Mail Barcode of each received mail item, the captured digital images taken by the mail item recipients utilizing the mail item recipient's personal mobile intelligent communications device, each Intelligent Mail Barcode of the captured digital images including a Mailer Identification Number, a Mailer Assigned Recipient Sequence number, and a Delivery Point Zip Code contained in encoded form within the Intelligent Mail Barcode;
B) the central server processing the Mailer Identification Number, the Mailer Assigned Recipient Sequence number, and the Delivery Point Zip Code to formulate Mail Item Data; and,
C) storing information relating to the Mail Item Data for a number of mail items into a mail item information database as part of the central server, or a remote central server.

13) The method as recited in claim 12 further comprising: generating reports descriptive of a plurality of the received mail items based upon the verified actual reception of the mail items.

14) A method of processing a specific mail item sent by a mail item sender and received as a received mail item by a specific mail item recipient so as to provide for electronic interaction between the mail item sender and the mail item recipient, the received mail item including an Intelligent Mail Barcode on an area of the mail item visible outer surface, the Intelligent Mail Barcode having a height based bar code containing in encoded form, a number of Intelligent Mail Barcode elements including a Mailer Identification Number, a Mailer Assigned Recipient Sequence number, and a Delivery Point Zip Code, the method comprising:
A) capturing with the mail item recipient's own personal camera equipped mobile intelligent communications device a digital image of at least a portion of a visible outer surface of the received mail item, the portion including in an area of the image the Intelligent Mail Barcode of the received mail item;
B) decoding the Intelligent Mail Barcode of the captured digital image to determine, for that specific mail item, a specific received mail item Mailer Identification Number and a specific received mail item Mailer Assigned Recipient Sequence number; and,
C) accessing a mail item database in one or more steps utilizing the specific received mail item Mailer Identification Number and the specific received mail item Mailer Assigned Recipient Sequence number to determine a response to the receipt of the specific mail item which is based upon the specific received mail item Mailer Identification Number and the specific received mail item Mailer Assigned Recipient Sequence number.

15) The method of claim 14 further comprising: determining an electronic web address based upon the specific received mail item Mailer Identification Number and the specific received mail item Mailer Assigned Recipient Sequence number and invoking a browser component on the mail item recipient's own personal camera equipped mobile intelligent communications device to access information from a location specified by the electronic web address.

16) The method of claim 14 further comprising: sending information formed from different web page templates stored in a web server according to a type or category of mail item recipient.

17) A method of processing data relating to a number of mail items received by one or more mail item recipients, the mail items including on the outside of the mail item, a human intelligible written or printed destination address and an Intelligent Mail Barcode, the method comprising:
A) providing or distributing to at least one of the one or more mail item recipients, an application for running on a camera equipped personal mobile intelligent communications device;
B) capturing, using the application on personal mobile intelligent communications device of the mail item recipient, a digital image of at least a portion of the outside of the mail item received by the mail item recipient, the digital image including an area containing the Intelligent Mail Barcode;
C) decoding the Intelligent Mail Barcode, from the captured one or more digital images of the recipient mail item, to obtain identified sender information of the mail item;
D) further decoding the Intelligent Mail Barcode, from the captured one or more digital images of the mail item, to obtain identified recipient information of the recipient mail item; and
E) transferring electronically to a central server apparatus, the identified sender information and the identified recipient information for use in responding to receipt of the mail item and to a response by the mail item recipient.

18) The method of claim 17 further comprising: utilizing the identified sender information and a database to determine an identified sender and sending an electronic message to a sender server, the sender server associated with the identified sender.

19) A method of collecting data describing a number of mail items received by one or more mail recipients, the mail items including on the mail item a destination address and a Postal Service Routing Bar Code, the method comprising:
A) providing an incentive or request to one or more the mail item recipients to capture a digital image of at least a portion on the mail item received by that mail recipient, the capturing of the digital image performed by the mail item recipient utilizing the recipient own personal mobile communication device;
B) decoding the Postal Service Routing Bar Code, from the captured one or more digital images of the mail item for obtaining identified sender information of the mail item;
C) further decoding the Postal Service Routing Bar Code, from the captured one or more digital images of the mail item for obtaining identified recipient information of the received mail item; and
D) transferring electronically to a central server apparatus, mail item information derived from the identified sender information and the identified recipient information.

20) The method of claim 19, further comprising: using information relating to a number of identified senders to track incoming mail and to generate reports descriptive of mail items verified as received by mail item recipients.

21) The method of claim 19, further comprising: transferring electronically the information describing the identified recipient of the mail item to the sender to obtain further information associated with the mail piece that includes one or more of billing account information and subscription account information.

22) The method of claim 19, further comprising: transferring electronically to the identified sender, information describing the identified recipient of the mail item which is utilized to generate or provide response relating to a charitable request.

23) The method of claim 19, further comprising: transferring electronically the information describing the identified recipient of the mail item to the identified sender to obtain information pertaining to a commercial solicitation.

24) The method of claim 19, further comprising: transferring electronically the recipient identification information to the identified sender to obtain electronic discount coupons or rewards.

25) A method of collecting data from processing a number of mail items, the mail items each including a visible Written Sender Address appearing in either printed or hand-written form, and a visible Encoded Postal Routing Bar Code such as a United States Post Office Intelligent Mail Barcode (IMB), each received mail item sent by a mail sender and received by an individual mail item recipient, the method comprising:
A) the individual mail item recipient activating a camera of a personal mobile intelligent communications device to capture a digital image of the Written Sender Address and the Encoded Postal Routing Bar Code of the received mail item;
B) the device processing the digital image and decoding the Encoded Postal Routing Bar Code to obtain Postal Routing Code Content comprising at least:
i) a Mailer Identification Number of the mail item, and
ii) a Recipient Sequence number of the mail item, or a Delivery Point ZIP code of the mail item;
C) the device transferring electronically the Postal Routing Bar Code Content to a receiving centrally located server; and,
D) the receiving centrally located server processing the received Postal Routing Bar Code Content and formulating Mail Item Data and then storing the Mail Item Data for the number of the mail items into a database on the receiving central server or sending electronic information relating to the Mail Item data to a second central server.

26) The method of claim 24, further comprising:
utilizing the Mail Item Data for a number of identified senders to track incoming mail and to organize or generate reports descriptive of the incoming mail received by individual mail recipients.

27) The method of claim 24, further comprising:
the centrally located server transferring electronically the information describing the identified recipient of the mail item to the sender to obtain a bill due amount and due date from a billing database.

28) The method of claim 24, further comprising:
transferring electronically, to the identified sender, recipient information describing the identified recipient of the mail item, the recipient information being then utilized to obtain information from a database about a donation request.

29) The method of claim 24, further comprising:
the server transferring electronically the information describing the identified recipient of the mail item to the identified sender to obtain information about a commercial solicitation.

30) The method of claim 24, further comprising:
the server transferring electronically the recipient identification information to the sender to obtain discount coupons.
